(19) United States
(12) Patent Application Publication
(10) Pub. No.: US 2018/0123933 A1
(43) Pub. Date: May 3, 2018

(54) METHOD, SWITCHING DEVICE AND PACKET CAPTURING SYSTEM

(71) Applicant: FUJITSU LIMITED, Kawasaki-shi (JP)

(72) Inventors: Hiroyuki YAMASHIMA, Kawasaki (JP); Kazuhiro Suzuki, Kawasaki (JP)

(73) Assignee: FUJITSU LIMITED, Kawasaki-shi (JP)

(21) Appl. No.: 15/788,257

(22) Filed: Oct. 19, 2017

(30) Foreign Application Priority Data
Nov. 2, 2016 (JP) 2016-215342

(51) Int. Cl. H04L 12/26; H04L 29/06

(52) U.S. Cl. CPC H04L 43/106; H04L 69/161; H04L 69/28; H04L 43/18; H04L 43/028; H04L 43/04

(57) ABSTRACT

A method includes receiving, by a switching device coupled to a network, a first packet transmitted through the network, generating, by the switching device, a first mirror packet of the received first packet by performing a first mirroring processing on the received first packet, the first mirror packet including first identification information identifying the first mirror packet, generating, by the switching device, a first time stamp packet including the first identification information and first time information indicating a first time when the first mirroring processing is performed, transmitting, by the switching device, the first mirror packet and the first time stamp packet to a storage device, and storing, in the storage device, the first mirror packet and the first time stamp packet transmitted from the switching device.

### CROSS-REFERENCE TO RELATED APPLICATION

This application is based upon and claims the benefit of priority of the prior Japanese Patent Application No. 2016-215342, filed on Nov. 2, 2016, the entire contents of which are incorporated herein by reference.

### FIELD

The embodiments discussed herein are related to a method, a switching device and a packet capturing system.

### BACKGROUND

In some cases, an operator who provides users with service (which may also be simply referred to as an operator hereinafter) may acquire and analyze a communication packet (which may also be simply referred to as a packet hereinafter) flowing through a network to understand the operating condition of a system or a network in operation.

Specifically, a switching device arranged on a network acquires a packet flowing through the network and performs mirroring of the acquired packet. Then, the switching device transmits a packet generated from the mirroring to a packet capture device that analyzes a packet (which may also be simply referred to as a capture device hereinafter). Then, the capture device accumulates in a storage device the packet received from the switching device and analyzes the packet accumulated in the storage unit, as appropriate. In the following, a packet targeted for mirroring in the switching device (packet by the switching device to be acquired from the network) is referred to as a system packet, and a packet to be generated from mirroring of the system packet (packet to be analyzed by the capture device) is referred to as a mirror packet. Reference documents include Japanese Laid-open Patent Publication Nos. 2007-324706, 2007-174668, 2015-076780, and 2013-192128.

### SUMMARY

According to an aspect of the invention, a method includes receiving, by a switching device coupled to a network, a first packet transmitted through the network, generating, by the switching device, a first mirror packet of the received first packet by performing a first mirroring processing on the received first packet, the first mirror packet including first identification information identifying the first mirror packet, generating, by the switching device, a first time stamp packet including the first identification information and first time information indicating a first time when the first mirroring processing is performed, transmitting, by the switching device, the first mirror packet and the first time stamp packet to a storage device, and storing, in the storage device, the first mirror packet and the first time stamp packet transmitted from the switching device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of an information processing system 10;

FIG. 2 is a diagram illustrating a hardware configuration of a switching device 1;

FIG. 3 is a diagram illustrating a hardware configuration of a capture device 2;

FIG. 4 is a functional block diagram of the switching device 1;

FIG. 5 is a functional block diagram of the capture device 2;

FIG. 6 is a flowchart describing an outline of packet capture processing in a first embodiment;

FIG. 7 is a flowchart describing the outline of the packet capture processing in the first embodiment;

FIG. 8 is a diagram describing the outline of the packet capture processing in the first embodiment;

FIG. 9 is a diagram describing the outline of the packet capture processing in the first embodiment;

FIG. 10 is a flowchart describing details of the packet capture processing in the first embodiment;

FIG. 11 is a flowchart describing details of the packet capture processing in the first embodiment;

FIG. 12 is a flowchart describing details of the packet capture processing in the first embodiment;

FIG. 13 is a flowchart describing details of the packet capture processing in the first embodiment;

FIG. 14 is a flowchart describing details of the packet capture processing in the first embodiment;

FIG. 15 is a flowchart describing details of the packet capture processing in the first embodiment;

FIG. 16 is a flowchart describing details of the packet capture processing in the first embodiment;

FIG. 17 is a flowchart describing details of the packet capture processing in the first embodiment;

FIG. 18 is a flowchart describing details of the packet capture processing in the first embodiment;

FIG. 19 is a flowchart describing details of the packet capture processing in the first embodiment;

FIGS. 20A, 20B, 20C, and 20D are diagrams describing a specific example of a mirror packet and a time stamp packet;

FIGS. 21A and 21B are diagrams describing a specific example of management information 231;

FIGS. 22A and 22B are diagrams describing the specific example of management information 231;

FIGS. 23A and 23B are diagrams describing the specific example of management information 231;

FIG. 24 is a flowchart describing details of packet capture processing in a second embodiment;

FIG. 25 is a flowchart describing details of the packet capture processing in the second embodiment;

FIG. 26 is a flowchart describing details of the packet capture processing in the second embodiment;

FIG. 27 is a flowchart describing details of the packet capture processing in the second embodiment;

FIG. 28 is a flowchart describing details of the packet capture processing in the second embodiment;

FIG. 29 is a flowchart describing details of the packet capture processing in the second embodiment; and

FIG. 30 is a flowchart describing details of the packet capture processing in the second embodiment.

### DESCRIPTION OF EMBODIMENTS

When mirror packets are transmitted from a switching device to a capture device, due to a difference in a communication path that each mirror packet takes, order in which the mirror packets reach the capture device may vary from order in which the mirror packets are transmitted. For this reason, the capture device sorts mirror packets stored in a storage device before analyzing the mirror packets, for example.

However, unless information indicating the time when the switching device transmits a mirror packet is included in the mirror packet, the capture device may not sort mirror packets stored in a storage device. In addition, the capture device may not determine in which of a system packet and a mirror packet the communication order has changed.

Thus, it is possible that the switching device adds the information indicating the time when mirroring is performed to a generated mirror packet. This allows the capture device to sort mirror packets based on the time when mirroring of each packet is performed.

In this case, however, due to added information indicating the time when mirroring is performed, packet size of the mirror packet may be larger than the maximum transmission unit (MTU) which is maximum size of data that the switching device may transmit in one communication session. Hence, the switching device has to transmit the mirror packet after performing fragmentation on the mirror packet, which increases processing load involved in transmission and reception of mirror packets.

In response, it is possible that when analyzing a mirror packet, an operator sets MTU which is smaller than the MTU of the switching device by size of information added to the mirror packet for a transmission source device of a system packet. This allows the switching device to make size of the mirror packet to which the information indicating the time when mirroring is performed is added be of same size as the MTU of the switching device. Thus, the switching device does not have to perform fragmentation when transmitting the mirror packet to the capture device.

However, any change to setting of the MTU of the transmission source device of a mirror packet may affect a result of analysis of the mirror packet in the capture device. Hence, the capture device may not acquire a reliable analysis result, in this case.

[Configuration of an Information Processing System]

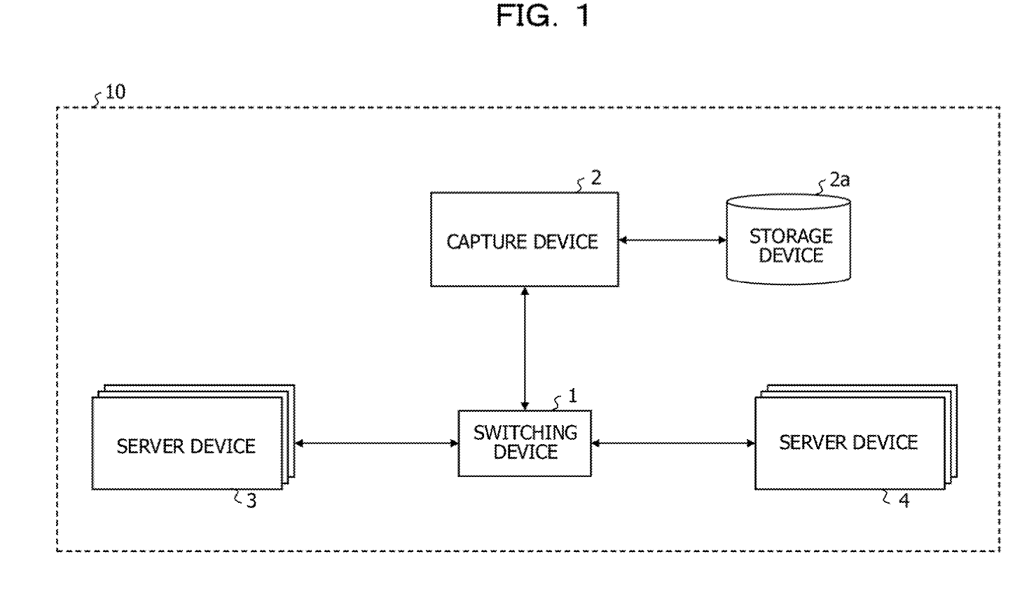

FIG. 1 is a diagram illustrating an overall configuration of an information processing system 10. The information processing system 10 illustrated in FIG. 1 has a switching device 1, a capture device 2 (hereinafter also referred to as an accumulation device 2), a server device 3, and a server device 4. Note that the switching device 1 and the capture device 2 are collectively referred to as a packet capture system.

The server device 3 and the server device 4 are a physical machine family, each including one or more physical machines, for example, and each perform processing for an operator to provide users with service. Then, the server device 3 and the server device 4 transmit and receive a system packet, as appropriate.

The switching device 1 is a network device arranged between the server device 3 and the server device 4. Specifically, when a system packet that is transmitted from the server device 3 or the server device 4 goes through the switching device 1, the switching device 1 acquires that system packet. Then, the switching device 1 mirrors the acquired system packet to generate a mirror packet, and transmits the generated mirror packet to the capture device 2. Note that in the following, a description is given on the assumption that the switching device 1 is set to transmit a packet such as a mirror packet generated by itself to the capture device 2.

When receiving a mirror packet from the switching device 1, the capture device 2 accumulates the received mirror packet in a storage device 2a. Then, when the operator or a user transmits an instruction to analyze the mirror packet by way of an operating terminal (not illustrated), for example, the capture device 2 analyzes the mirror packet stored in the storage device 2a.

In addition, each of the switching device 1, the capture device 2, the server device 3, and the server device 4 may include a virtual machine generated on one or more physical machine.

In the information processing system 10 as described above, when a mirror packet is transmitted from the switching device 1 to the capture device 2, an communication order may change in a period before the mirror packet reaches the capture device 2. Thus, the capture device 2 has to sort mirror packets stored in the storage device 2a before analyzing the mirror packet, for example.

However, if the information indicating the time when the switching device 1 transmits the mirror packet is not included in the mirror packet, the capture device 2 may not sort mirror packets stored in the storage device 2a. In addition, the capture device 2 may not determine in which of a system packet and a mirror packet the communication order has changed.

Thus, the switching device 1 adds information indicating the time when mirroring is performed, for example, to the generated mirror packet. This allows the capture device 2 to perform sorting of the mirror packets, or the like, based on the time when mirroring of each packet is performed.

In this case, however, packet size of the mirror packet may be larger than MTU, which is maximum size of data that may be transmitted by the switching device 1 in one communication session, due to added information indicating the time when mirroring is performed. Hence, the switching device 1 has to transmit the mirror packet to the capture device 2 after performing fragmentation on the mirror packet, which increases processing load involved in transmission and reception of mirror packets.

In contrast to this, when analyzing a mirror packet, the operator may set MTU which is smaller than the MTU of the switching device 1 by size of information added to the mirror packet for a transmission source device of a system packet (server device 3 or server device 4). This allows the switching device 1 to make size of the mirror packet to which the information indicating the time when mirroring is performed is added be of same size as the MTU of the switching device 1. Thus, the switching device 1 does not have to perform fragmentation when transmitting a mirror packet to the capture device 2.

However, any change to setting of MTU of the transmission source device of a mirror packet may affect a result of analysis of the mirror packet in the capture device 2. Hence, the capture device 2 may not acquire a reliable analysis result, in this case.

Thus, the switching device 1 generates a mirror packet by performing mirroring on a system packet flowing through a network. The switching device 1 also generates a time stamp packet including identification information that uniquely identifies the generated mirror packet and time when mirroring is performed. The identification information is, for example, information included in a header of a mirror packet (hereinafter also referred to as header information). Then, the switching device 1 transfers the generated time stamp packet and mirror packet to the capture device 2.

In addition, the capture device 2 identifies a mirror packet and a time stamp packet, respectively, that include same identification information from the packet received from the switching device 1, and associates the identified mirror packet with time included in the identified time stamp packet and stores the mirror packet in the storage device 2a.

More specifically, the switching device 1 transmits to the capture device 2 a time stamp packet including the time when mirroring is performed, in addition to the mirror packet that is generated by mirroring the system packet. Then, when storing the mirror packet in the storage device 2a, the capture device 2 associates the mirror packet with time included in the time stamp packet corresponding to that mirror packet and stores the mirror packet.

This allows the switching device 1 and the capture device 2 to associate a mirror packet with time when that mirror packet is generated (time when mirroring is performed) and store the mirror packet in the storage device 2a, without changing setting of the MTU or the like or performing fragmentation on the mirror packet. Then, the capture device 2 may analyze a mirror packet, referring to the time when the mirror packet is generated.

[Hardware Configuration of the Information Processing System]

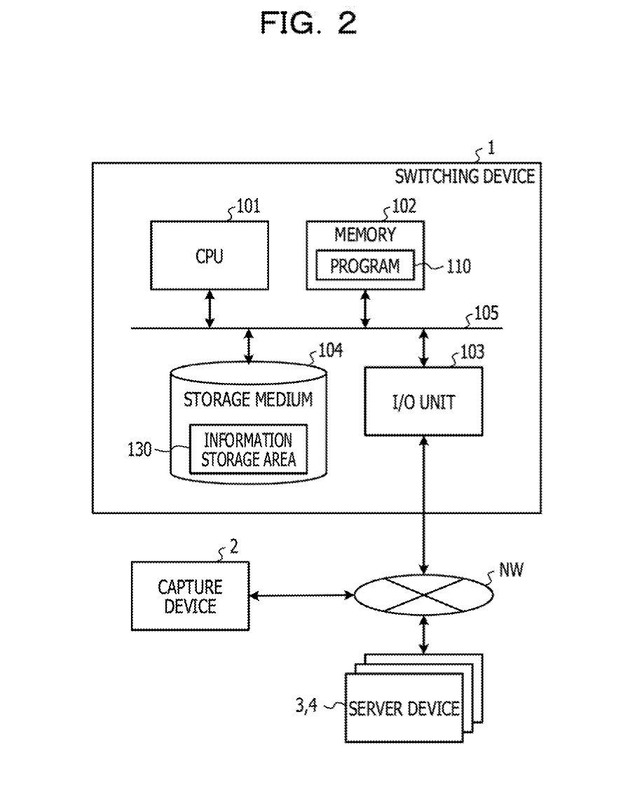

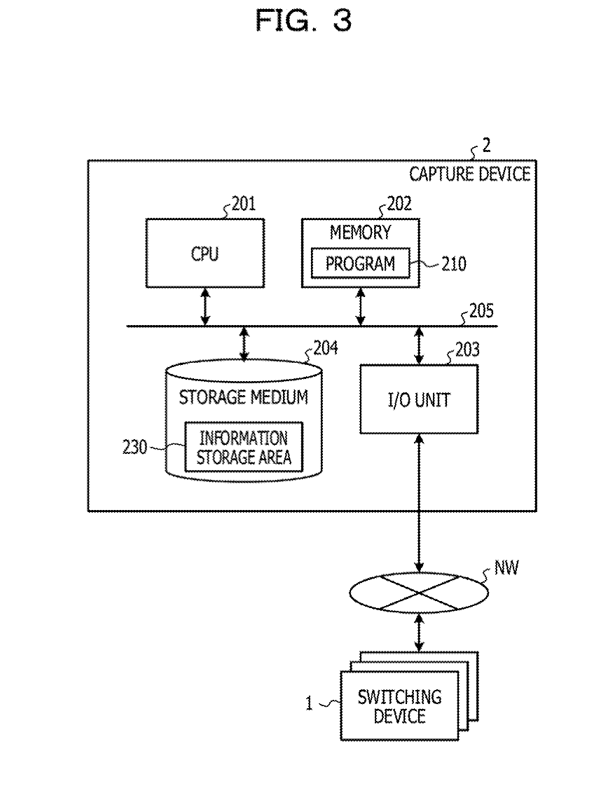

A hardware configuration of the information processing system 10 is described hereinafter. FIG. 2 is a diagram illustrating a hardware configuration of the switching device 1. In addition, FIG. 3 is a diagram illustrating a hardware configuration of the capture device 2.

As illustrated in FIG. 2, the switching device 1 includes a CPU 101, which is a processor, a memory 102, an external interface (I/O unit) 103, and a storage medium 104. Each unit is coupled to each other by way of a bus 105.

The storage medium 104 stores a program 110 that performs processing to accumulate mirror packets (hereinafter also referred to as packet capture processing) in a program storage area (not illustrated) in the storage medium 104. In addition, the storage medium 104 has an information storage area 130 (hereinafter also referred to as a storage unit 130) that stores information to be used, for example, when the packet capture processing is performed.

When performing the program 110, the CPU 101 loads the program 110 from the storage medium 104 into the memory 102 and performs the packet capture processing in cooperation with the program 110. In addition, the external interface 103 communicates with the capture device 2, the server device 3, and the server device 4 by way of a network NW formed by an intranet or Internet or the like, for example.

In addition, as illustrated in FIG. 3, the capture device 2 has a CPU 201, which is a processor, a memory 202, and an external interface (I/O unit) 203, and a storage medium 204. Each unit is coupled to each other by way of a bus 205.

The storage medium 204 stores a program 210 that performs processing to perform the packet capture processing in a program storage area (not illustrated) in the storage medium 204. In addition, the storage medium 204 has an information storage area 230 (hereinafter also referred to as a storage unit 230) that stores information to be used, for example, when the packet capture processing is performed. Note that the information storage area 230 corresponds to the storage device 2a described in FIG. 1, for example.

When performing the program 210, the CPU 201 loads the program 210 from the storage medium 204 into the memory 202 and performs the packet capture processing in cooperation with the program 210. In addition, the external interface 203 communicates with the switching device 1 by way of the network NW formed by the intranet or Internet or the like, for example.

[Function of the Information Processing System]

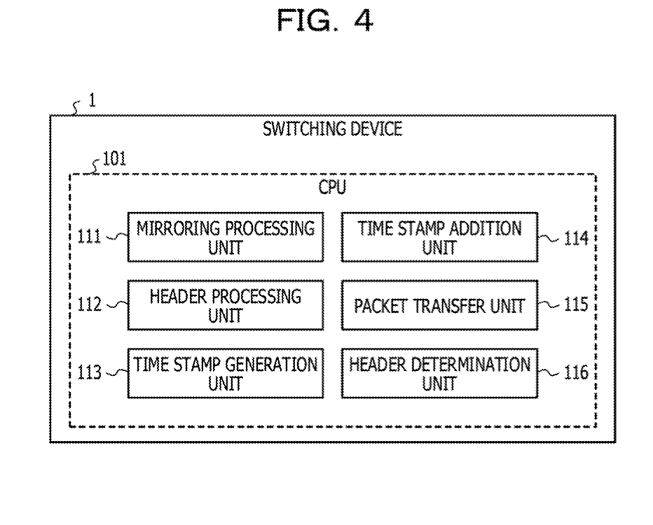

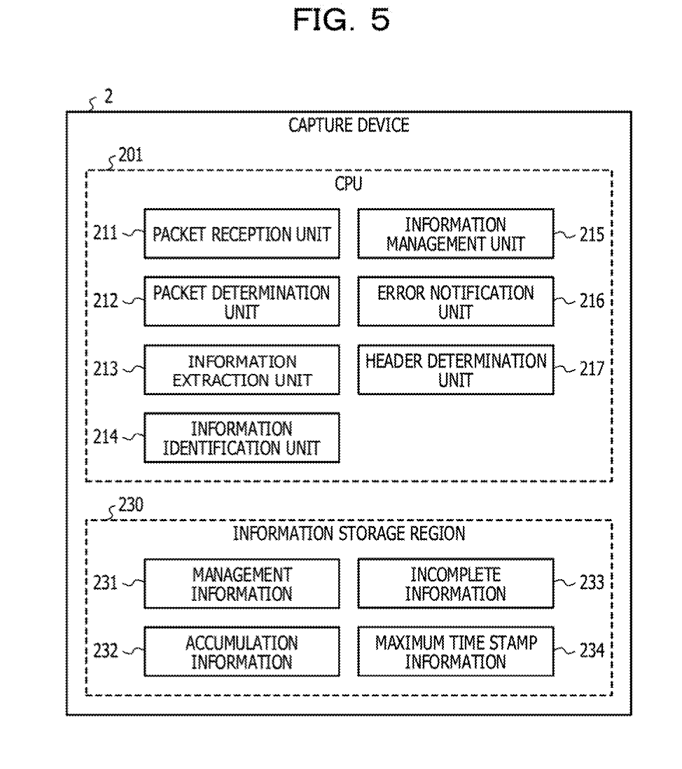

Functions of the information processing system 10 are described hereinafter. FIG. 4 is a functional block diagram of the switching device 1. In addition, FIG. 5 is a functional block diagram of the capture device 2.

First, a functional block diagram of the switching device 1 is described. As illustrated in FIG. 4, in cooperation with the program 110, the CPU 101 of the switching device 1 operates, for example, as a mirroring processing unit 111, a header processing unit 112, a time stamp generation unit 113, a time stamp addition unit 114, a packet transfer unit 115, and a header determination unit 116. Note that the header processing unit 112, the time stamp generation unit 113, and the time stamp addition unit 114 are hereinafter collectively referred to as a time stamp packet generation unit.

The mirroring processing unit 111 acquires a system packet flowing through a network and generates a mirror packet by performing mirroring on the acquired system packet. Then, the packet transfer unit 115 transfers to the capture device 2 the mirror packet generated by the mirroring processing unit 111.

The header processing unit 112 replicates information (hereinafter also referred to as header information) included in a header of the mirror packet generated by the mirroring processing unit 111, for example. Specifically, when a protocol of a transport layer of the mirror packet generated by the mirroring processing unit 111 is transmission control protocol (TCP), the header processing unit 112 replicates, for example, a head of the mirror packet to a TCP Header, for example. In addition, when the protocol of a transport layer of the mirror packet generated by the mirroring processing unit 111 is user datagram protocol (UDP), the header processing unit 112 replicates, for example, the head of the mirror packet to the UDP header.

The time stamp generation unit 113 generates time stamp information, which is information indicating the current time. Then, the time stamp addition unit 114 generates a time stamp packet by adding time stamp information generated by the time stamp generation unit 113 to a header replicated by the header processing unit 112. Then, the packet transfer unit 115 transmits the time stamp packet generated by the time stamp addition unit 114 to the capture device 2.

If a header of a system packet acquired by the mirroring processing unit 111 is a TCP header, the header determination unit 116 determines whether or not a time stamp field is present in an option field of that TCP header. Then, if the time stamp field is present, the header determination unit 116 sets the current time (time stamp information) to the time stamp field. Subsequently, the packet transfer unit 115 transfers to the capture device 2 a mirror packet for which the header determination unit 116 sets the time stamp information in the time stamp field.

Note that the header processing unit 112, the time stamp generation unit 113, and the time stamp addition unit 114 may generate a time stamp packet even in a case in which a protocol of the transport layer of the mirror packet generated by the mirroring processing unit 111 is any protocol other than the TCP or UDP.

A functional block diagram of the capture device 2 is described hereinafter. As illustrated in FIG. 5, in cooperation with the program 210, the CPU 201 of the capture device 2 operates, for example, as a packet reception unit 211, a packet determination unit 212, an information extraction unit 213, an information identification unit 214, an information management unit 215, an error notification unit 216, and a header determination unit 217. Then, in the information storage area 230 are stored, for example, management information 231, accumulation information 232, incomplete information 233, and maximum time stamp information 234.

The packet reception unit 211 receives a mirror packet and a time stamp packet transmitted by the switching device 1. Then, the packet determination unit 212 makes a determination on whether or not the packet received by the packet reception unit 211 is a mirror packet (whether or not the packet received by the packet reception unit 211 is a time stamp packet).

The information extraction unit 213 extracts header information included in a header of the packet received by the packet reception unit 211. The information identification unit 214 determines whether or not the header information extracted by the information extraction unit 213 is present in the management information 231. The management information 231 is information that associates the header information, information included in the mirror packet, and time stamp information included in the time stamp packet.

If the header information extracted by the information extraction unit 213 is present in the management information 231, the information management unit 215 associates information included in the packet received by the packet reception unit 211 with the header information that is present and stores the information in the information storage area 230. Specifically, if the packet received by the packet reception unit 211 is a mirror packet, the information management unit 215 associates predetermined information included in the packet received by the packet reception unit 211 (all information included in the packet or any information other than the header of the information included in the packet) with the header information that is present, and stores the information in the information storage area 230. In addition, if the packet received by the packet reception unit 211 is a time stamp packet, the information management unit 215 associates time stamp information included in the time stamp packet received by the packet reception unit 211 and stores the information in the information storage area 230.

On the other hand, if the header information extracted by the information extraction unit 213 is not present in the management information 231, the information management unit 215 stores the information that associates the header information extracted by the information extraction unit 213 with the information included in the packet received by the packet reception unit 211, as a part of the management information 231, in the information storage area 230. Specifically, if the packet received by the packet reception unit 211 is a mirror packet, the information management unit 215 stores, as a part of the management information 231, the information that associates the header information extracted by the information extraction unit 213 with the predetermined information included in the mirror packet received by the packet reception unit 211, in the information storage area 230. In addition, if the packet received by the packet reception unit 211 is a time stamp packet, the information management unit 215 stores, as a part of the management information 231, the information that associates the header information extracted by the information extraction unit 213 with the time stamp information included in the time stamp packet received by the packet reception unit 211, in the information storage area 230.

If a predetermined error occurs, the error notification unit 216 notifies an operating terminal of the operator or the user, for example, of the error.

If the header of the mirror packet received by the packet reception unit 211 is a TCP header, the header determination unit 217 determines whether or not a time stamp field is present in an option field of that TCP header. Then, if the time stamp field is present, the header determination unit 217 extracts time stamp information set in the time stamp field that is present. Subsequently, the information management unit 215 stores as a part of the management information 231 information that associates the header information extracted by the information extraction unit 213, predetermined information included in the mirror packet received by the packet reception unit 211, and the time stamp information extracted by the header determination unit 217, in the information storage area 230.

In addition, the information management unit 215 deletes information corresponding to the information stored in the information storage area 230 from the management information 231. The incomplete information 233 and the maximum time stamp information 234 are described below.

### First Embodiment

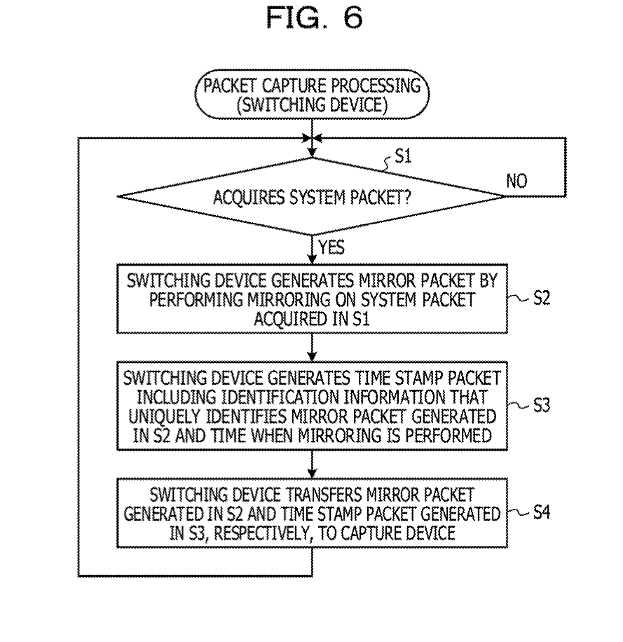

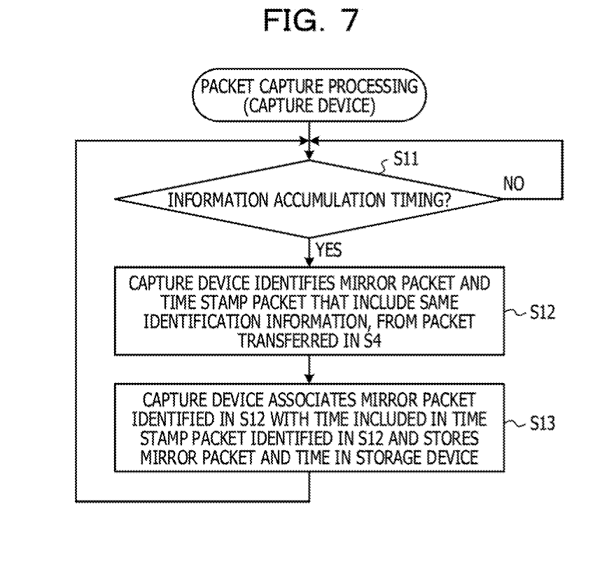

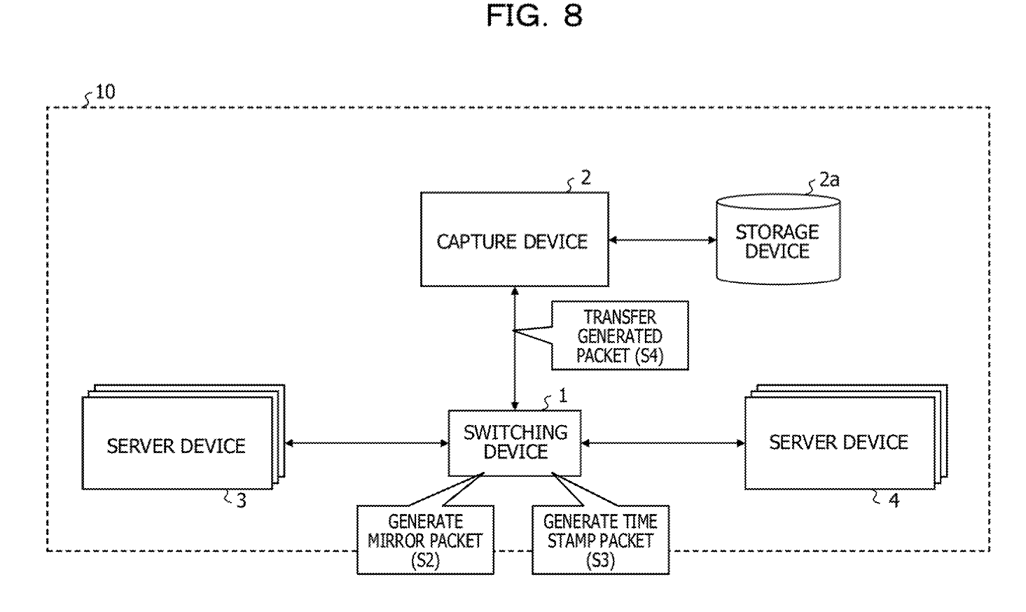

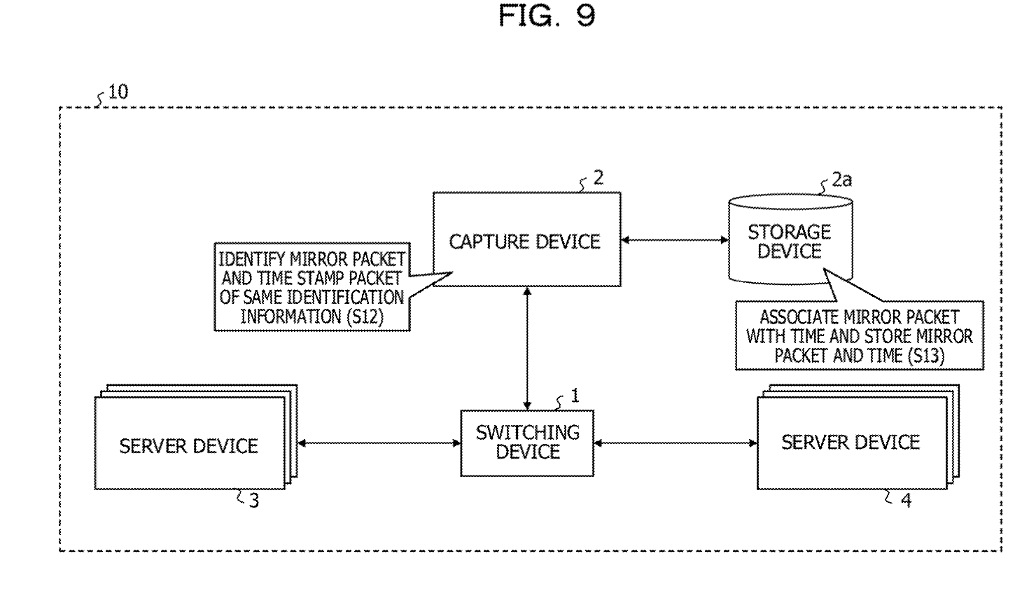

A first embodiment is described hereinafter. FIGS. 6 and 7 are a flowchart describing an outline of packet capture processing in the first embodiment. In addition, FIGS. 8 and 9 each are a diagram describing an outline of the packet capture processing in the first embodiment. The packet capture processing in the first embodiment illustrated in FIGS. 6 and 7 is outlined with reference to FIGS. 8 and 9.

As illustrated in FIG. 6, the switching device 1 waits until the switching device 1 acquires a system packet (NO of S1). More specifically, the switching device 1 waits until a system packet that goes through the switching device 1 (system packet transmitted by a server device 3 or the like) is generated.

Then, when acquiring a system packet (YES of S1), as illustrated in FIG. 8, the switching device 1 generates a mirror packet by performing mirroring on the system packet acquired in the processing of S1 (S2). Furthermore, as illustrated in FIG. 8, the switching device 1 generates a time stamp packet including identification information (header information) that uniquely identifies the mirror packet generated in the processing of S2 and the time when the mirroring is performed (time stamp information) (S3).

Then, as illustrated in FIG. 8, the switching device 1 transfers the mirror packet generated in the processing of S2 and the time stamp packet generated in the processing of S3, respectively, to the capture device 2 (S4).

On the other hand, as illustrated in FIG. 7, the capture device 2 waits until information accumulation timing (NO of S11). The information accumulation timing is timing when content of a packet received from the switching device 1 is stored in the information storage area 230. The information accumulation timing may be regular timing, for example.

Then, when the information accumulation timing is reached (YES of S11), as illustrated in FIG. 9, the capture device 2 identifies (extracts) a mirror packet and a time stamp packet, respectively, that include same identification information, from the packet that the switching device 1 transfers to the capture device 2 in the processing of S4 (S12). More specifically, of the mirror packets received from the switching device 1, the capture device 2 identifies a mirror packet reception of a time stamp packet corresponding to which is also complete.

Then, as illustrated in FIG. 9, the capture device 2 associates the mirror packet identified in the processing of S12 with the time included in the time stamp packet identified in the processing of S12, and stores the mirror packet in the information storage area 230 (S13). Specifically, the capture device 2 associates any information other than the header information included in the mirror packet with the time included in the time stamp packet and stores the information in the information storage area 230.

More specifically, the switching device 1 transmits to the capture device 2 a time stamp packet including the time when mirroring is performed, in addition to a mirror packet that is generated through mirroring of a system packet. Then, when storing the mirror packet in the storage device 2a, the capture device 2 associates the mirror packet with time included in the time stamp packet corresponding that mirror packet and stores the mirror packet.

This allows the switching device 1 and the capture device 2 to associate a mirror packet with time when that mirror packet is generated (time when mirroring is performed) and stores the mirror packet in the storage device 2a, without changing setting of the MTU or the like or performing fragmentation on the mirror packet. Then, the capture device 2 may analyze the mirror packet, referring to the time when the mirror packet is generated.

### Details of the First Embodiment

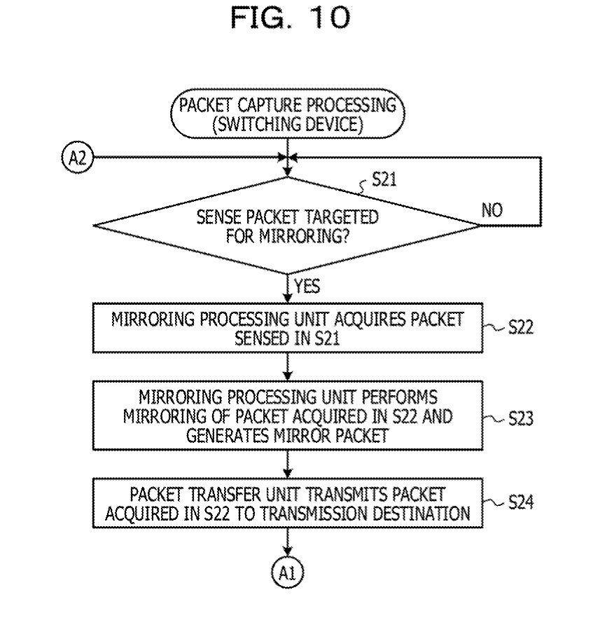

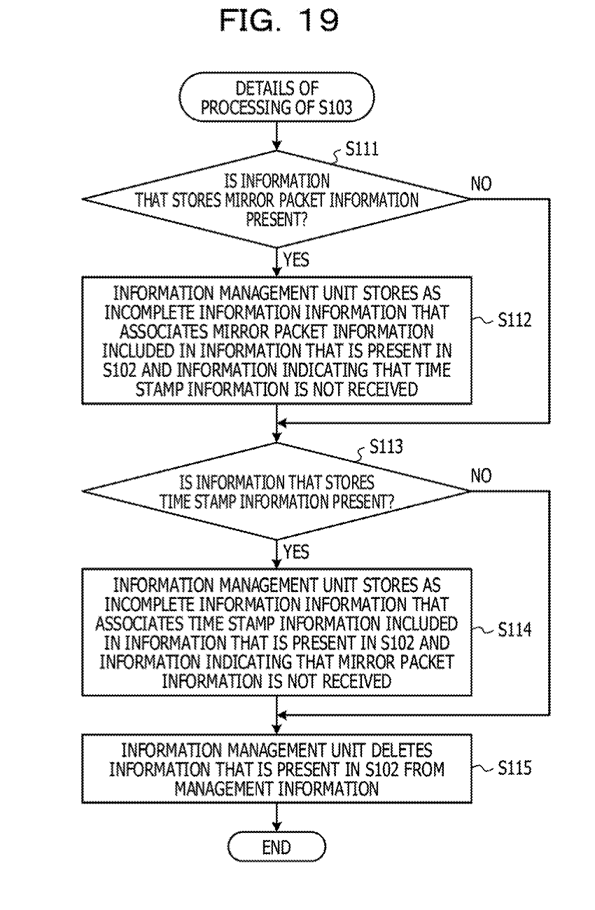

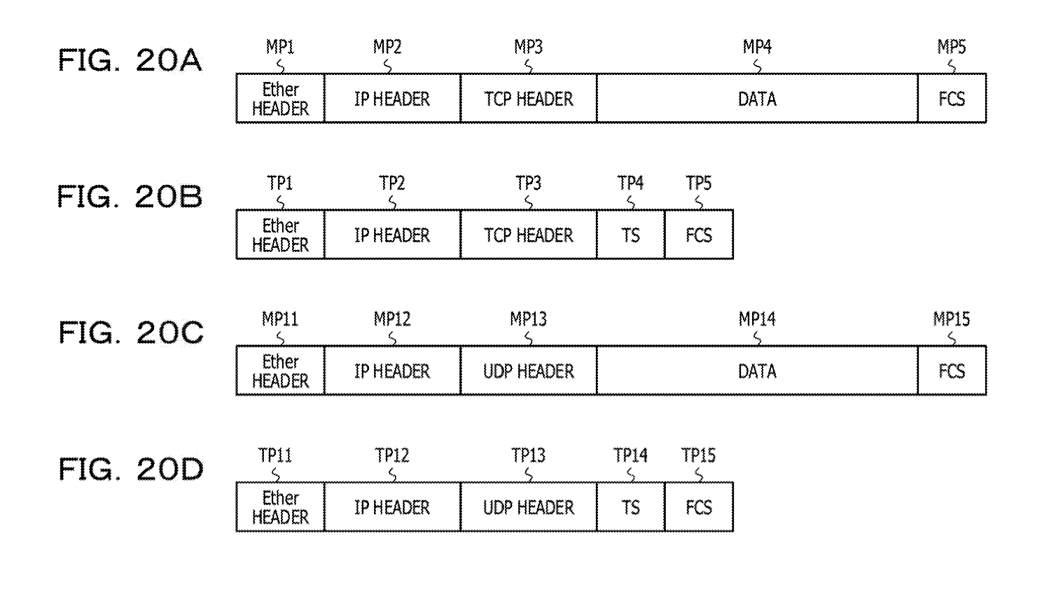

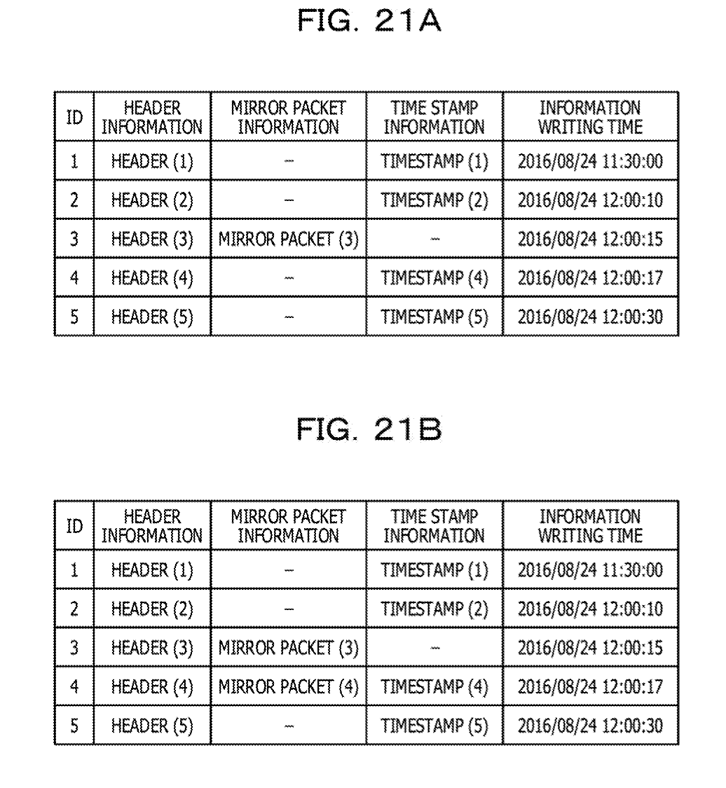

Details of the first embodiment are described hereinafter. FIGS. 10 to 19 are a flowchart describing details of the packet capture processing in the first embodiment. In addition, FIGS. 20A, 20B, 20C, and 20D are diagrams describing a specific example of a mirror packet and a time stamp packet. FIGS. 21A, 21B, 22A, 22B, 23A, and 23B are diagrams describing a specific example of management information 231.

[Packet Capture Processing in the Switching Device]

First, packet capture processing in the switching device 1 is described. The mirroring processing unit 111 of the switching device 1 waits until the mirroring processing unit 111 senses that a system packet targeted for mirroring goes through the switching device 1 (NO of S21). Specifically, the mirroring processing unit 111 refers to mirroring target information (not illustrated) and waits until the mirroring processing unit 111 senses that a system packet included in the mirroring target information goes through the switching device 1.

Then, when sensing that the system packet targeted for mirroring goes through the switching device 1 (YES of S21), the mirroring processing unit 111 acquires the sensed system packet (S22). Then, the mirroring processing unit 111 generates a mirror packet by performing mirroring on the acquired system packet (S23). In addition, the packet transfer unit 115 transmits the system packet acquired in the processing of S22 to a transmission destination (S24).

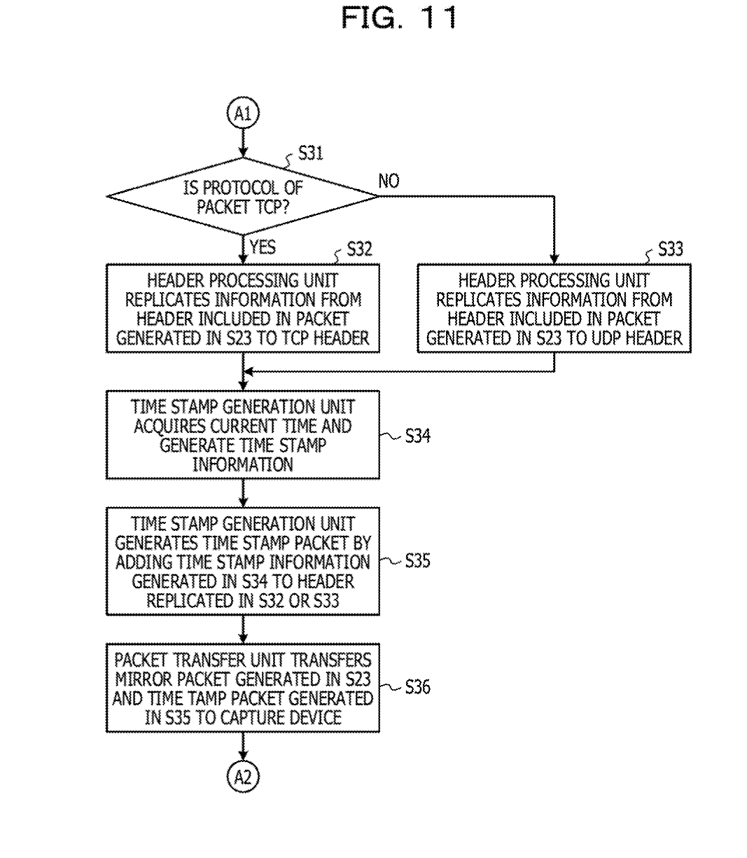

Subsequently, as illustrated in FIG. 11, the header processing unit 112 of the switching device 1 determines whether or not a protocol of the mirror packet generated in the processing of S23 is TCP (whether or not the protocol is UDP) (S31). Then, when the protocol of the mirror packet is TCP (YES of S31), the header processing unit 112 replicates information from a head of the mirror packet generated in the processing of S23 to a TCP header, for example (S32). On the other hand, when the protocol of the mirror packet generated in the processing of S23 is UDP (NO of S31), the header processing unit 112 replicate information from the head included in the mirror packet generated in S23 to the UDP header (S33).

Note that if information that may ensure uniqueness of each packet is included, the header processing unit 112 may not replicate all information from the header to the TCP header (UDP header) of the information included in the mirror packet. Specifically, the header processing unit 112 may replicate only an IP identifier included in an internet protocol (IP) header and fragment offset information, for example. In addition, the header processing unit 112 may replicate only a checksum included in the TCP header (UDP header), for example.

Then, after processing of S32 or S33, the time stamp generation unit 113 of the switching device 1 acquires the current time to generate time stamp information (S34). Then, the time stamp addition unit 114 generates a time stamp packet by adding the time stamp information generated in the processing of S34 to the header replicated in the processing of S32 or S33 (S35). A specific example of the mirror packet and the time stamp packet is described hereinafter.

[Specific Example of a Mirror Packet and a Time Stamp Packet]

FIGS. 20A, 20B, 20C, and 20D are diagrams describing a specific example of a mirror packet and a time stamp packet. FIG. 20A is a diagram describing the specific example of a mirror packet when a protocol of a transport layer is TCP, and FIG. 20B is a diagram describing a specific example of the time stamp packet when the protocol of the transport packet is TCP. In addition, FIG. 20C is a diagram describing the specific example of the mirror packet when the protocol of the transport layer is UDP, and FIG. 20D is a diagram describing the specific example of the time stamp packet when the protocol of the transport layer is UDP.

The mirror packet when the protocol of the transport layer is TCP includes, sequentially from the head, an Ethernet header illustrated in MP1 in FIG. 20A (hereinafter also referred to as an Ether header), an IP header illustrated in MP2, and a TCP header illustrated in MP3 in FIG. 20A. Then, the mirror packet when the protocol of the transport layer is TCP includes, sequentially from the head, data illustrated in MP4 in FIG. 20A and frame check sequence (FCS) illustrated in MP5 in FIG. 20A.

In addition, the time stamp packet when the protocol of the transport layer is TCP includes, sequentially from the head, an Ethernet (registered trademark) header indicated in TP1 in FIG. 20B, an IP header illustrated in TC2 in FIG. 20B, and a TCP header illustrating TC3 in FIG. 20B. Then, the time stamp packet when the protocol of the transport layer is TCP includes, sequentially from the head, time stamp information (simply also referred to as TS hereinafter) illustrated in TP4 in FIG. 20B and FCS illustrated in TP5 in FIG. 20B.

In addition, the mirror packet when the protocol of the transport layer is UDP includes, sequentially from the head, an Ethernet header illustrated in MP11 in FIG. 20C, an IP header illustrated in MP12 in FIG. 20C, and a UDP header illustrated in MP13 in FIG. 20C. Then, the mirror packet when the protocol of the transport layer is UDP includes, sequentially from the head, data illustrated in MP14 in FIG. 20C and FCS illustrated in MP15 in FIG. 20C.

In addition, the time stamp packet when the protocol of the transport layer is UDP includes, sequentially from the head, an Ethernet header illustrated in TP11 in FIG. 20D, an IP header illustrated in TP12 in FIG. 20D, and a UDP header illustrating TP13 in FIG. 20D. Then, the time stamp packet when the protocol of the transport layer is UDP includes, sequentially from the head, time stamp information illustrated in TP14 in FIG. 20D and FCS illustrated in TP15 in FIG. 20D.

Turning back to FIG. 11, the packet transfer unit 115 transfers the mirror packet generated in the processing of S23 and the time stamp packet generated in the processing of S35 to the capture device 2 (S36). Then, the mirroring processing unit 111 performs the processing after S21 again.

[Management Information Generation Processing in the Capture Device]

Then, of the packet capture processing in the capture device 2, processing to generate management information 231 (hereinafter also referred to as management information generation processing) is descried hereinafter.

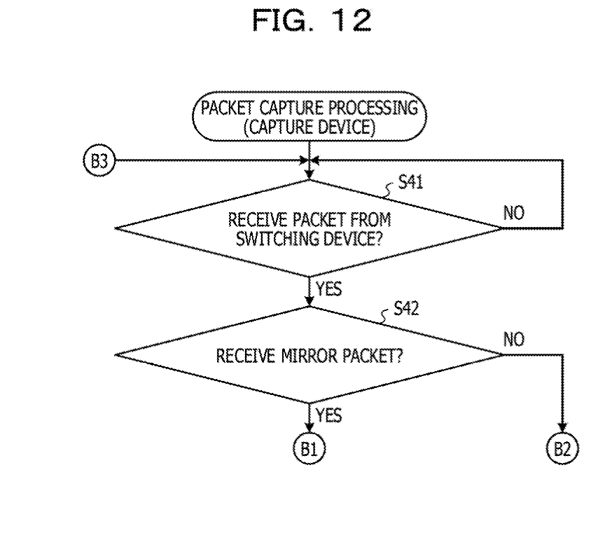

As illustrated in FIG. 12, the packet reception unit 211 of the capture device 2 waits until the packet reception unit 211 receives a packet from the switching device 1 (NO of S41). More specifically, the packet reception unit 211 waits until the packet reception unit 211 receives a mirror packet of a time stamp packet from the switching device 1.

Then, when the packet reception unit 211 receives a packet from the switching device 1 (YES of S41), the packet determination unit 212 of the capture device 2 whether or not the packet received by the packet reception unit 211 is a mirror packet (S42). Specifically, the packet determination unit 212 may refer to size of the packet received by the packet reception unit 211 to determine whether or not the received packet is a mirror packet.

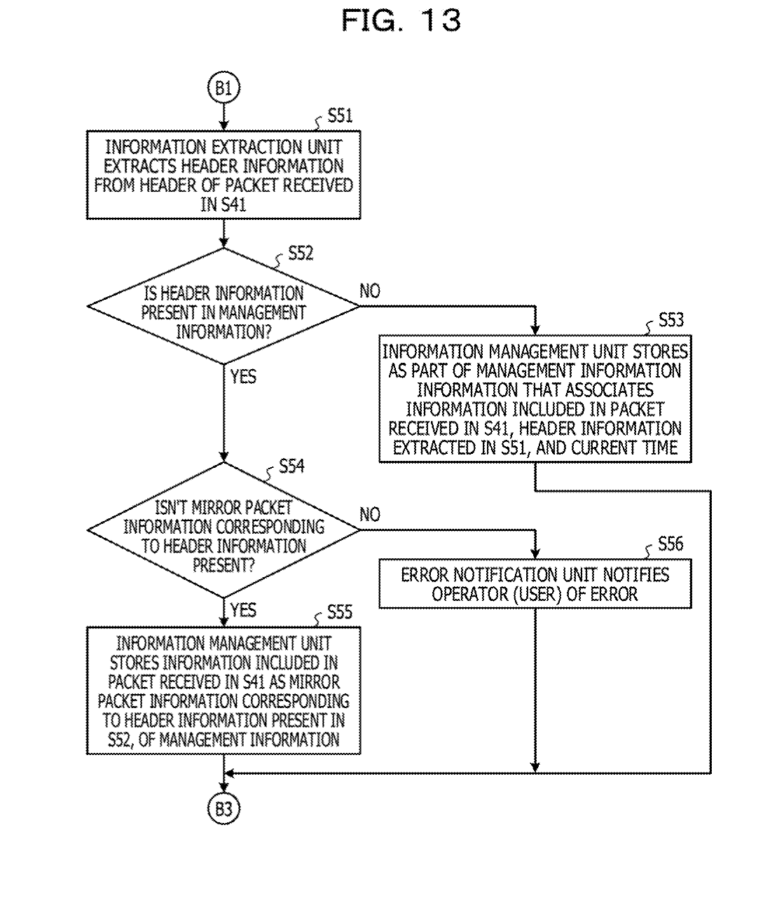

As a result, if the packet received by the packet reception unit 211 is a mirror packet (YES of S42), as illustrated in FIG. 13, the information extraction unit 213 of the capture device 2 extracts header information from a header of the mirror packet received in the processing of S41 (S51). Specifically, the information extraction unit 213 extracts, as header information, information replicated by the header processing unit 112 of the switching device 1, in the processing of S32 or S33. Thus, if the header processing unit 112 replicates only a checksum, the information extraction unit 213 extracts the checksum as the header information.

Then the information identification unit 214 of the capture device 2 determines whether or not the header information extracted in the processing of S51 is present in the management information 231 (S52). A specific example of the management information 231 is described hereinafter.

[Specific Example of the Management Information]

FIGS. 21A, 21B, 22A, 22B, 23A, and 23B are diagrams describing a specific example of the management information 231. The management information 231 has, as items, an “ID” that identifies each piece of information included in the management information 231, “header information” for which header information is set, and “mirror packet information” for which information included in a mirror packet (all information included in a mirror packet, for example). In addition, the management information 231 illustrated in FIGS. 21 to 23 has, as items, “Time stamp information” for which time stamp information included in a time stamp packet and “Information writing time” indicating the time when each piece of information included in the management information 231 is written.

Specifically, in the management information 231 illustrated in FIG. 21A, for “information having the “ID” of “3”, a “header (3)” is set as the “Header information, a “Mirror packet (3)” is set as the “Mirror packet information”, and “08/24/2016 12:00:15” is set as the “Information writing time”. Then, “-” representing that no information is yet set is set in the “Time stamp information” in the information having the “ID” of “3”.

In addition, in the management information 231 illustrated in FIG. 21A, for “information having the “ID” of “4”, a “header (4)” is set as the “Header information, a “Time stamp (1)” is set as the “Time stamp information”, and “08/24/2016 12:00:17” is set as the “Information writing time”. Then, “-” representing that no information is yet set is set in the “Mirror packet information” in the information having the “ID” of “4”. A description of other information included in FIG. 21A is omitted.

Thus, if the “header (4)” is extracted in the processing of S51, for example, the information identification unit 214 determines that the header information extracted in the processing of S51 is present in the management information 231 (S52).

Turning back to FIG. 13, if the header information extracted in the processing of S51 is present in the management information 231 (YES of S52), the information identification unit 214 determines whether or not the mirror packet information corresponding to the header information that is present in the processing of S52 is present in the management information 231 (S54).

As a result, when the mirror packet information is not present (YES of S54), the information management unit 215 of the capture device 2 stores in the information storage area 230 information included in the mirror packet received in the processing of S41 as mirror packet information corresponding to the header information that is present in the processing of S52 of the management information 231 (S55).

Specifically, as illustrated in FIG. 21B, the information management unit 215 sets a “mirror packet (4)” for the “mirror packet information” of the information with the “header information” being a “header (4)” (information with the “ID” being “4”).

Note that in the processing of S55, the information management unit 215 may store all of information included in the mirror packet received in the processing of S41, as the mirror packet information corresponding to the header information that is present in the processing of S52. In addition, the information management unit 215 may store all of information that is included posterior to the TCP header (UDP header), of the information included in the mirror packet, as the mirror packet information corresponding to the header information that is present in the processing of S52.

Furthermore, in the processing of S55, the information management unit 215 may set the mirror packet received in the processing of S41 in any storage area other than the information storage area 230. In this case, instead of information included in the mirror packet, the information management unit 215 may store information (address or offset) related to a storage area in which the mirror packet received in the processing of S41 is stored, as the mirror packet information corresponding to the header information that is present in the processing of S52.

On the other hand, when the mirror packet information is present in the processing of S54 (NO of S54), the error notification unit 216 of the capture device 2 notifies an operating terminal (not illustrated) of an operator or a user, for example, that an error occurs (S56). More specifically, since the mirror packet information corresponding to the header information that is present in the processing of S52 is already present, it indicates that a mirror packet having same header information as certain time stamp packet information is received multiple times. Thus, in this case, the error notification unit 216 notifies the operator or the user that the error occurs.

In addition, in the processing of S52, if the header information extracted in the processing of S51 is not present in the management information 231 (NO of S52), the information management unit 215 stores in the information storage area 230 as part of the management information 231 information that associates the information included in the mirror packet received in the processing of S41, the header information extracted in the processing of S51, and the current time (S53).

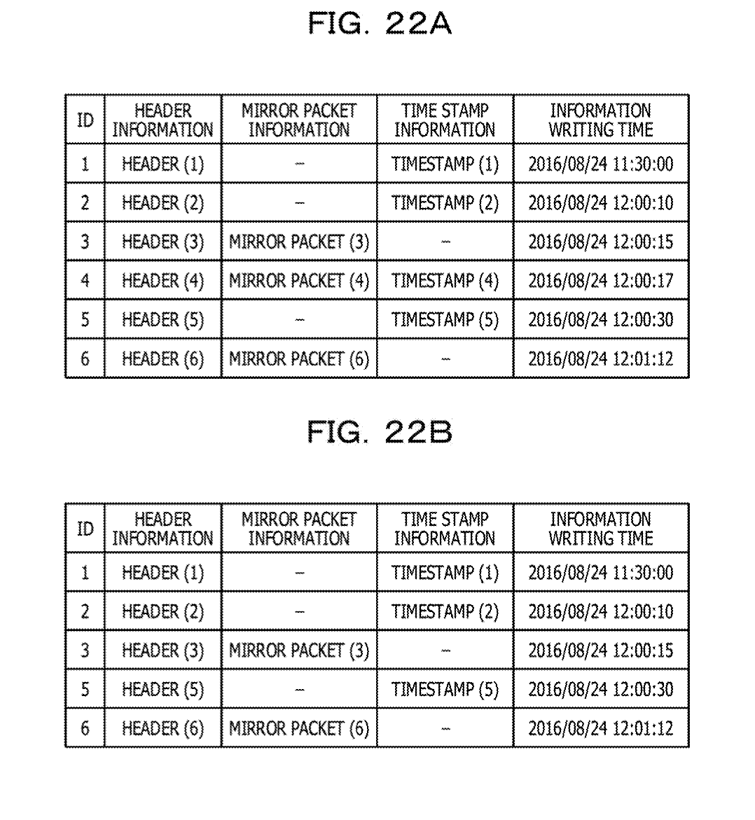

Specifically, for example, information with a “header (6)” being set for the “head information” is not present in the management information 231 illustrated in FIG. 21B. Thus, if the header information extracted in the processing of S51 is the “header 6”, as illustrated in FIG. 22A, the information management unit 215 adds the information with the “ID” being “6” to the management information 231.

Then, after the processing in S53, S55, or S56, the packet reception unit 211 performs the processing after S41 again.

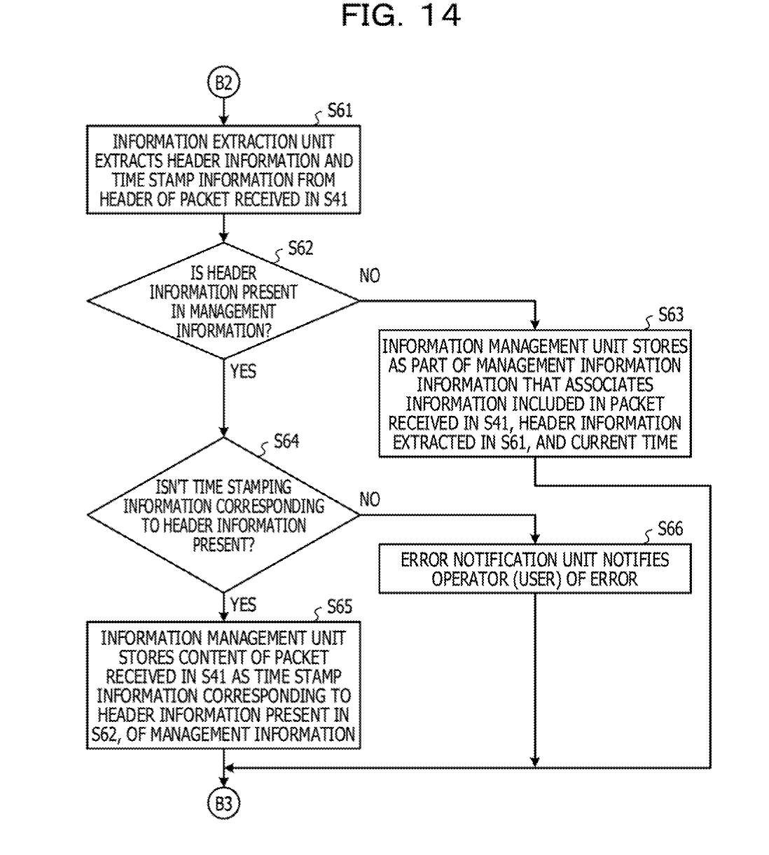

On the other hand, if the packet that the packet reception unit 211 receives in the processing of S42 illustrated in FIG. 12 is a time stamp packet (NO of S42), the information extraction unit 213 extracts header information from the header of the time stamp packet received in the processing of S41, as illustrated in FIG. 14 (S61). Specifically, the information extraction unit 213 extracts the information that the header processing unit 112 of the switching device 1 replicates in the processing of S32 or S33. Thus, if the header processing unit 112 replicates only the checksum, the information extraction unit 213 extracts only the checksum as the header information. In addition, in this case, the information extraction unit 213 extracts the time stamp information from the time stamp packet received in the processing of S41 (S61).

Then, the information identification unit 214 determines whether or not the header information extracted in the processing of S61 is present in the management information 231 (S62). Then, if the header information is present in the management information 231 (YES of S62), the information identification unit 214 determines whether or not the time stamp information corresponding to the header information that is present in the processing of S62 is present in the management information 231 (S64).

As a result, if the time stamp information is not present (YES of S64), the information management unit 215 of the capture device 2 stores the time stamp information included in the time stamp packet received in the processing of S41 as the time stamp information corresponding to the header information that is present in the processing of S62, of the management information 231 (S65).

On the other hand, if the time stamp information is present (NO of S64), the error notification unit 216 of the capture device 2 notifies the operator or the user that the error occurs. More specifically, if the time stamp information corresponding to the header information that is present in the processing of S62 is already present, it indicates that a time stamp packet having same header information as certain mirror packet information is received multiple times. Thus, in this case, the error notification unit 216 notifies the operator or the user that the error occurs.

In addition, if the header information extracted in the processing of S61 is not present in the management information 231 in the processing of S62 (NO of S62), the information management unit 215 stores information that associates the time stamp information included in the time stamp packet received in the processing of S41, the header information extracted in the processing of S61, and the current time, as part of the management information 231 (S63).

Then, after the processing of S63, S65, or S66, the packet reception unit 211 performs the processing after S41 again.

[Management Information Generation Processing in the Capture Device (1)]

Then, of the packet capture processing in the capture device 2, processing to generate accumulation information 232 (hereinafter also referred to as accumulation information generation processing) is described hereinafter. Specifically, the accumulation information generation processing when the capture device 2 does not analyze a mirror packet in real time is described.

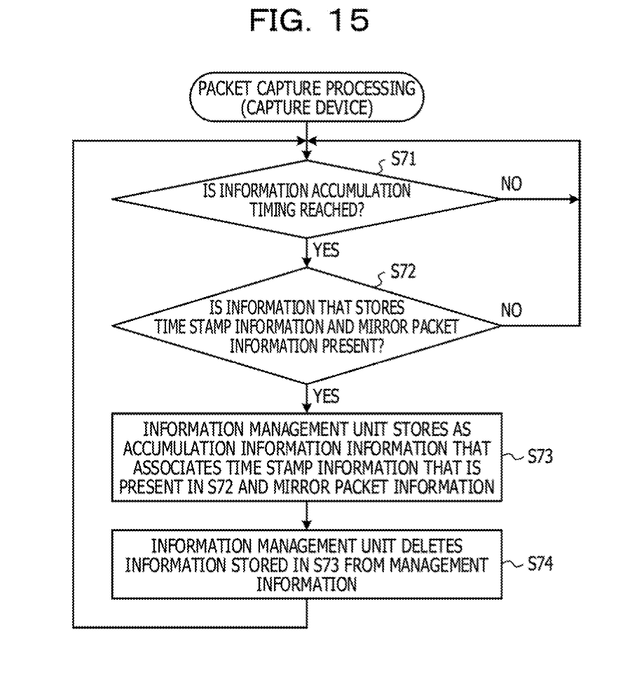

As illustrated in FIG. 15, the information identification unit 214 waits until the information accumulation timing (NO of S71). Then, when the information accumulation timing is reached (YES of S71), the information identification unit 214 determines whether or not information that stores both time stamp information and mirror packet information is present in the management information 231 (S72).

As a result, if the information that stores both the time stamp information and the mirror information is present in the management information 231 (YES o S72), the information management unit 215 stores as accumulation information 232 information that associates the time stamp information that is present in the processing of S72 and the mirror packet information (S73).

This allows the information management unit 215 to associate a mirror packet (information included in the mirror packet information) transmitted from the switching device 1 with the time when that mirror packet is generated and stores the mirror packet in the information storage area 230.

On the other hand, if the information that stores both the time stamp information and the mirror packet information is not present in the management information 231 (NO of S72), the information identification unit 214 performs the processing after S71 again.

Then, the information management unit 215 deletes from the management information 231 information associated with the time stamp information that is stored as the accumulation information 232 in the processing of S73 and the information corresponding to the mirror packet information (S74).

Specifically, for example, for information with the “ID” in the management information 231 illustrated in FIG. 22A being “4”, information is set in the “mirror packet information” and the “time stamp information”, respectively (YES of S72). Thus, the information management unit 215 stores as part of the accumulation information 232 in the information storage area 230 the information corresponding to the information with the “ID” in the management information 231 illustrated in FIG. 22A being “4”. Then, the information management unit 215 deletes the information with the “ID” being “4” from the management information 231 illustrated in FIG. 22A, as illustrated in the management information 231 illustrated in FIG. 22B.

This may stop the information management unit 215 from storing again the accumulation information 232 that is stored in the past, when storing the accumulation information 232 in the information storage area 230.

[Management Information Generation Processing in the Capture Device (2)]

The accumulation information generation processing when the capture device 2 analyzes a mirror packet in real time is described hereinafter.

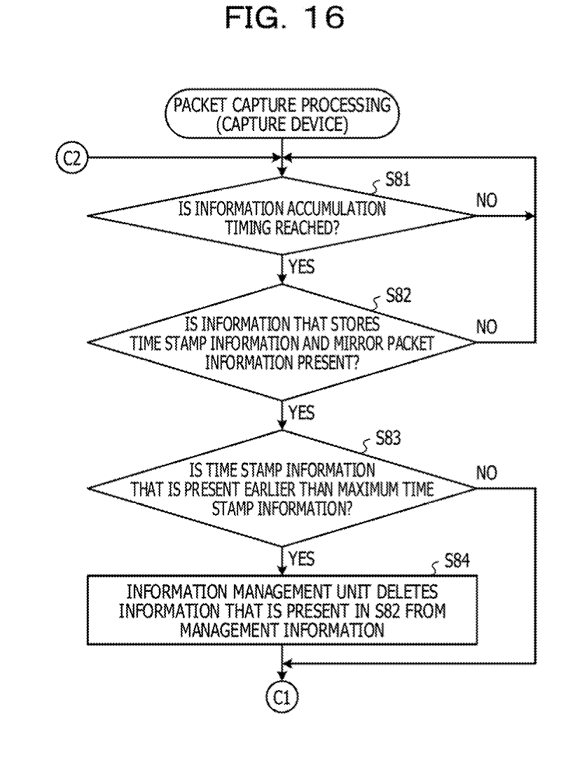

As illustrated in FIG. 16, the information identification unit 214 waits until the information accumulation timing (NO of S81). Then, when the information accumulation timing is reached (YES of S81), the information identification unit 214 determines whether or not information that stores both the time stamp information and the mirror packet information is present in the management information 231 (S82).

As a result, if the information that stores both the time stamp information and the mirror packet information is present in the management information 231 (YES of S82), the information identification unit 214 determines whether or not the time stamp information that is present in the processing of S82 indicates the time earlier than the maximum time stamp information 234 stored in the information storage area 230 (S83). The maximum time stamp information 234 is information indicating the last time of the time stamp information included in the accumulation information 232 stored in the information storage area 230. Note that an initial value of the maximum time stamp information 234 is the time which is sufficiently earlier than the current time, for example.

On the other hand, if the information that stores both the time stamp information and the mirror packet information is not present in the management information 231 (NO of S82), the information identification unit 214 performs the processing after S81 again.

Then, if the information that the time stamp information indicates the time earlier than the maximum time stamp information 234 is present in the information that is present in the processing of S82 (YES of S83), the information management unit 215 deletes from the management information 231 the information present in the processing in S82 (S84).

More specifically, if the capture device 2 analyzes a mirror packet in real time, there are some cases in which the capture device 2 does not have to analyze a mirror packet having time stamp information earlier than the mirror packet that is already analyzed. Thus, in this case, the information management unit 215 deletes the information that is present in the processing of S82 from the management information 231.

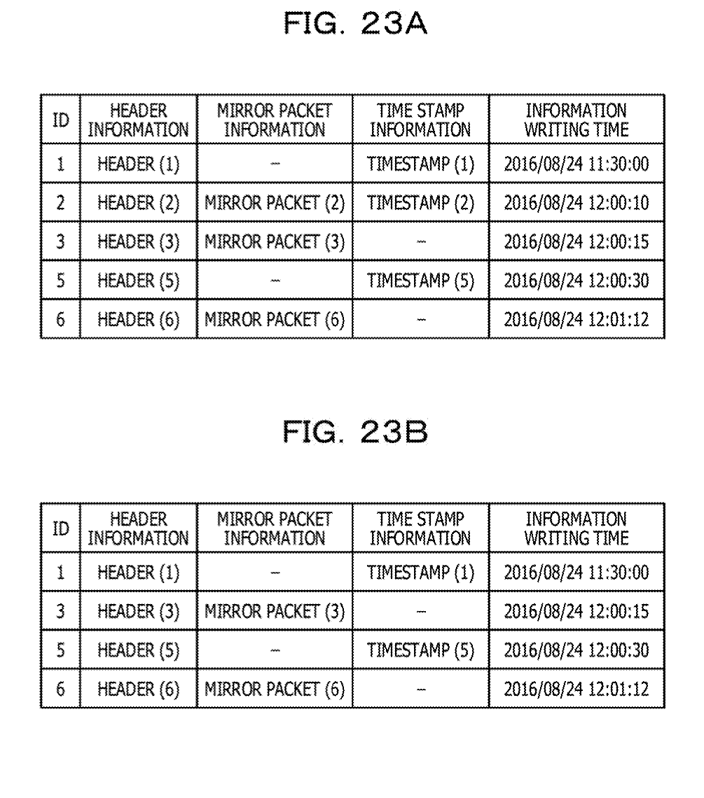

Specifically, for example, for information with the “ID” in the management information 231 illustrated in FIG. 23A being “2”, information is set in the “mirror packet information” and the “time stamp information”, respectively (YES of S82). Thus, if the information set for the “time stamp information” of the information with the “ID” being “2” indicates the time earlier than the maximum time stamp information 234, the information management unit 215 does not store as the accumulation information 232 in the information storage area 230 the information set for the “mirror packet information” and the “time stamp information” of the information with the “ID” being “2”. Then, the information management unit 215 deletes the information with the “ID” being “2” from the management information 231 illustrated in FIG. 23A, as illustrated in the management information 231 illustrated in FIG. 23B.

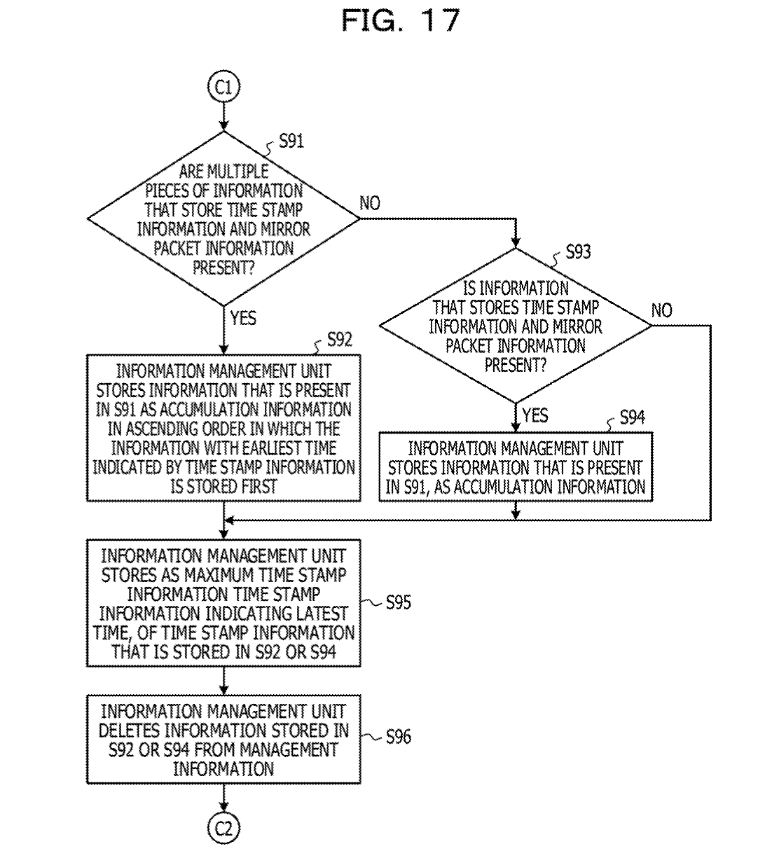

Subsequently, as illustrated in FIG. 17, the information management unit 215 determines whether or not multiple pieces of the information that stores both the time stamp information and the mirror packet information are present in the management information 231 (S91). Then, if the multiple pieces of the information that store both the time stamp information and the mirror packet information are present (YES of S91), the information management unit 215 stores, as the accumulation information 232 in the information storage area 230, the information that is present in the processing of S91 in the ascending order from the information that is stored at the earliest time indicated by the time stamp information (S92). On the other hand, if only one piece of the information that stores both the time stamp information and the mirror packet information is present (NO of S91, YES of S93), the information management unit 215 stores the information that is present in the processing of S93 as the accumulation information 232 in the information storage area 230 (S94). Note that if the information that stores both the time stamp information and the mirror packet information is not present (NO of S91, NO of S93), the information management unit 215 does not perform the processing of S94.

Then, the information management unit 215 stores as the maximum time stamp information 234 in the information storage area 230 time stamp information indicating the latest time (S95) of the time stamp information included in the accumulation information 232 that is stored in the processing of S92 or S94. Then, the information management unit 215 deletes the information stored in the processing of S92 or S94 from the management information 231 (S96).

[Timeout Processing in the Capture Device]

Of the packet capture processing in the capture device 2, processing to manage information that times out (hereinafter, timeout management processing) is described hereinafter.

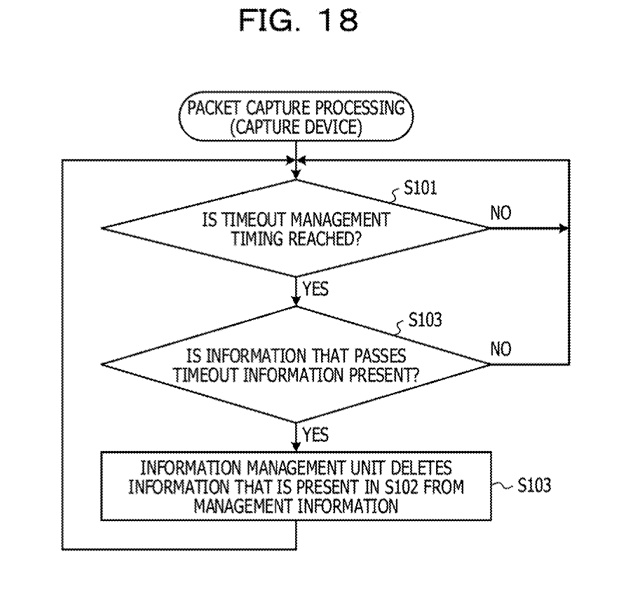

As illustrated in FIG. 18, the information management unit 215 waits until timeout management timing (NO of S101). Then, when the timeout management timing is reached (YES of S101), the information management unit 215 determines whether or not information for which after one of the mirror packet information and the time stamp information is set, a predetermined period of time elapses with the other information not being set is present in the management information 231 (S102). More specifically, the information management unit 215 makes a determination on whether or not information for which the time which is earlier than the current time by a predetermined period of time or longer is present at the “information writing time” of the management information 231.

Then, if the information for which the predetermined period of time elapses is present (YES of S102), the information management unit 215 deletes the information that is present in the processing of S102 from the management information 231 (S103). On the other hand, if the information for which the predetermined period of time elapses is not present (NO of S102), the information management unit 215 performs the processing after S101.

This allows the information management unit 215 to alleviate processing load when the management information 231 is updated.

Note that in the processing of S103, the information management unit 215 may store the information deleted from the management information 231 as information (hereinafter referred to as incomplete information 233) which is different from the accumulation information 232 in the information storage area 230. The processing of S103 when the incomplete information 233 is stored is described hereinafter.

[Details of the Processing of S103 when the Incomplete Information is Stored]

The information management unit 215 determines whether or not information that stores the mirror packet information is present in the information that is present in the processing of S102 (S111). If the information that stores the mirror packet information is present (YES of S111), the information management unit 215 stores, as part of the incomplete information 233 in the information storage area 230, information that associates the mirror packet information included in the information that is present in the processing of S102 and information indicating that the time stamp information is not received (S112). On the other hand, if the information that stores the mirror packet information is not present in the information that is present in the processing of S102 (NO of S111), the information management unit 215 does not perform the processing of S112.

Furthermore, the information management unit 215 further determines whether or not information that stores the time stamp information is present in the information that is present in the processing of S102 (S113). Then, if the information that stores the time stamp information is present in the information that is present in the processing of S102 (YES of S113), the information management unit 215 stores as part of the incomplete information 233 in the information storage area 230 information that associates the time stamp information included in the information that is present in the processing of S102 and the information indicating that mirror packet information is not received (S114). On the other hand, if the information that stores the time stamp information is not present in the information that is present in the processing of S102 (NO of S113), the information management unit 215 does not perform the processing of S114.

This allows the capture device 2 to refer to the incomplete information 233 stored in the information storage area 230 together, when analyzing a mirror packet. Thus, the capture device 2 may analyze the mirror packet in more detail.

Then, the information management unit 215 deletes information that is present in the processing of S102 from the management information 231 (S114).

### Second Embodiment

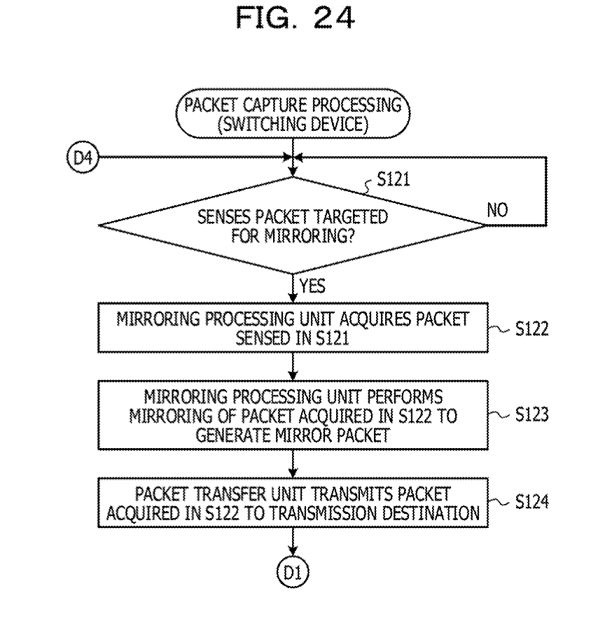

A second embodiment is described hereinafter. FIGS. 24 to 30 are flowcharts describing packet capture processing in the second embodiment.

When a time stamp field is present in a TCP header of a generated packet, a switching device 1 in the second embodiment sets time stamp information in the time stamp field without generating a time stamp packet. This allows the switching device 1 in the second embodiment to control processing load involved in generation of the time stamp packet. In addition, a capture device 2 in the second embodiment may control processing load involved in identification of a mirror packet and a time stamp packet that have same identification information (header information). A flowchart of the packet capture processing in the second embodiment is described hereinafter.

[Packet Capture Processing in the Switching Device]

First, the packet capture processing in the switching device 1 is described. A mirroring processing unit 111 waits until the mirroring processing unit 111 senses that a system packet targeted for mirroring goes through the switching device 1 (NO of S121). Then, if the mirroring processing unit 111 senses that a system packet targeted for mirroring goes through the switching device 1 (YES of S121), the mirroring processing unit 111 acquires the sensed system packet (S122).

Furthermore, the mirroring processing unit 111 generates a mirror packet by performing mirroring on the system packet acquired in the processing of S122 (S123). In addition, a packet transfer unit 115 transfers the system packet acquired in the processing of S122 to a transmission destination (S124).

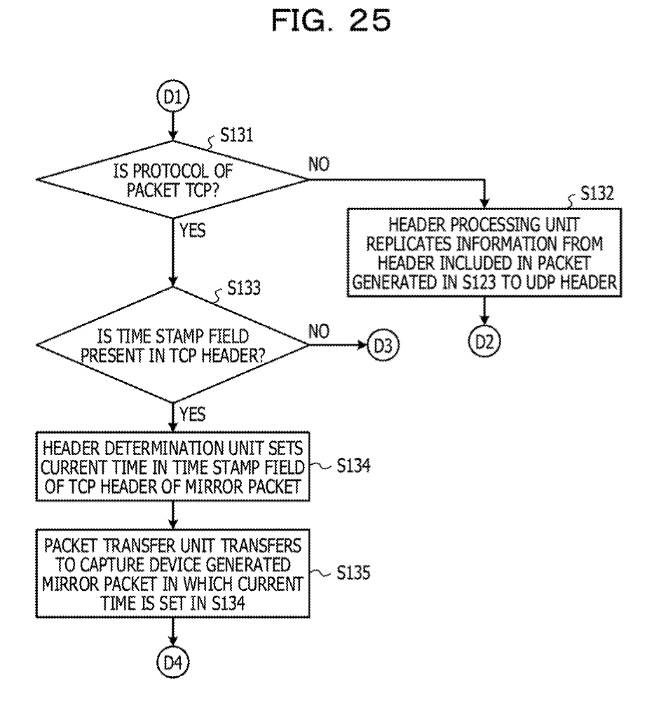

Subsequently, as illustrated in FIG. 25, a header processing unit 112 determines whether or not a protocol of a transport layer of the mirror packet generated in the processing of S123 is TCP (whether or not the protocol is UDP) (S131). As a result, if the protocol of the transport layer of the mirror packet generated in the processing of S123 is TCP (YES of S131), a header determination unit 217 determines whether or not a time stamp field is present in a TCP header (S133).

As a result, if the time stamp field is present in the TCP header (YES of S133), the header determination unit 217 sets the current time (time stamp information) in the time stamp field of the TCP header of the mirror packet (S134).

If this allows the switching device 1 to set the time stamp information in the TCP header of the mirror packet, the switching device 1 may transmit the time stamp information to the capture device 2 without generating a time stamp packet. In addition, in this case, when storing accumulation information 232 in an information storage area 230, the capture device 2 has no longer to perform processing to identify the time stamp packet corresponding to the mirror packet.

Then, the packet transfer unit 115 transfers to the capture device 2 the generated mirror packet (S135) in which the current time is set in the processing of S134. Subsequently, the mirroring processing unit 111 performs the processing after S121 again.

On the other hand, in the processing of S131, if the protocol of the transport layer of the mirror packet is UDP (NO of S131), the header processing unit 112 replicates information from a head included in the mirror packet generated in the processing of S123 to a UDP header (S132), for example.

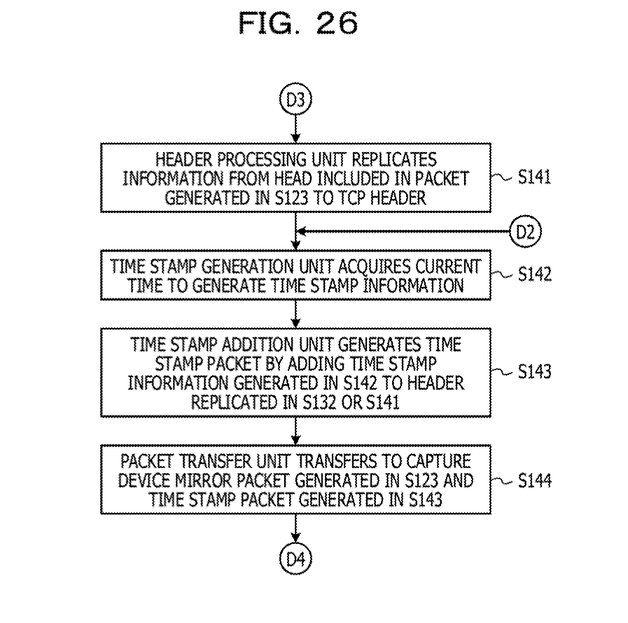

In addition, in processing of S133, if the time stamp field is not present in the TCP header (NO of S133), as illustrated in FIG. 26, the header processing unit 112 replicates information from a head included in the mirror packet generated in the processing of S123 to the TCP header, for example (S141).

Then, after the processing of S132 or S141, a time stamp generation unit 113 acquires the current time to generate time stamp information (S142). Furthermore, a time stamp addition unit 114 generates a time stamp packet by adding the time stamp information generated in the processing of S142 to the header replicated in the processing of S132 or S141 (S143). Subsequently, the packet transfer unit 115 transfers to the capture device 2 the mirror packet generated in the processing of S123 and the time stamp packet generated in the processing of S143 (S144). Then, the mirroring processing unit 111 performs the processing after S121 again.

More specifically, if the protocol of the transport layer of the generated mirror packet is UDP, the switching device 1 performs processing of the same content as the case of the first embodiment. In addition, even if the protocol of the transport layer of the generated mirror packet is UDP, the switching device 1 performs processing of the same content as the case of the first embodiment if no time stamp field is present in the TCP header.

[Management Information Generation Processing in the Capture Device]

Of the packet capture processing in the capture device 2, management information generation processing is described hereinafter. Note that since accumulation information generation processing and timeout management processing in the second embodiment are same as the accumulation information generation processing and the timeout management processing in the first embodiment, a description is omitted.

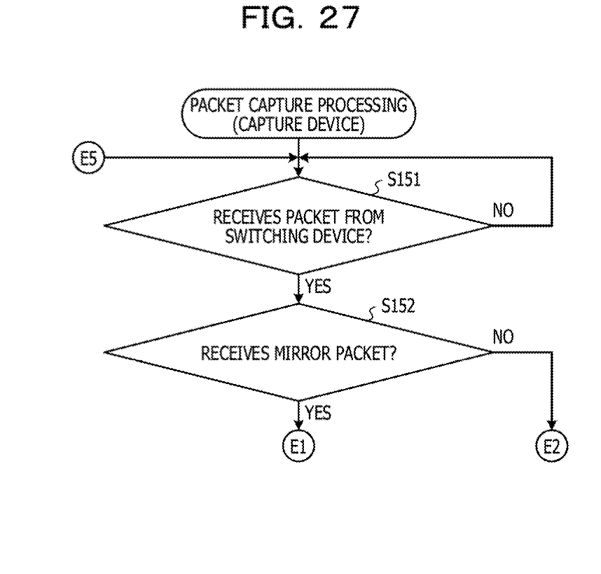

As illustrated in FIG. 27, a packet reception unit 211 waits until the packet reception unit 211 receives a packet from the switching device 1 (NO of S151). Then, when the packet reception unit 211 receives the packet from the switching device 1 (YES of S151), a packet determination unit 212 determines whether or not the packet received by the packet reception unit 211 is a mirror packet (S151).

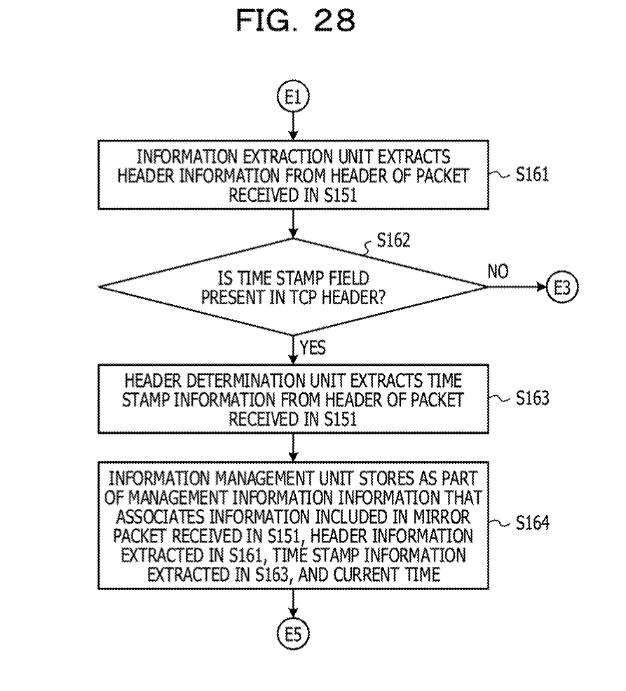

As a result, if the packet received by the packet reception unit 211 is a mirror packet (YES of S152), as illustrated in FIG. 28, a header determination unit 217 extracts header information from a header of the mirror packet received in the processing of S151 (S161). Then, the header determination unit 217 determines whether or not a time stamp field is present in a TCP header (S162).

As a result, if the time stamp field is present in the TCP header (YES of S162), the header determination unit 217 extracts time stamp information from the mirror packet received in the processing of S151 (S163). Subsequently, the information management unit 215 stores as part of management information 231 in the information storage area 230 information that associates the header information extracted in the processing of S161, information included in the mirror packet received in the processing of S151, the time stamp information extracted in the processing of S163, and the current time (S164).

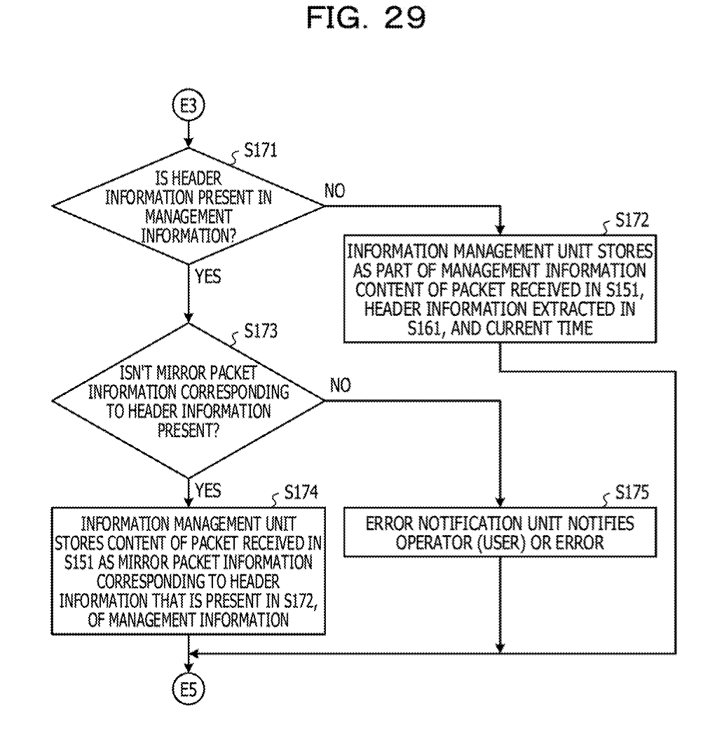

On the other hand, if the time stamp field is not present in the TCP header in the processing of S162 (NO of S162), as illustrated in FIG. 29, the information identification unit 214 determines whether or not the header information extracted in the processing of S161 is present in the management information 231 (S171). Then, if the header information extracted in the processing of S161 is present in the management information 231 (YES of S171), the information identification unit 214 determines whether or not the mirror packet information corresponding to the header information that is present in the processing of S171 is present in the management information 231 (S173).

As a result, if the mirror packet information is not present (YES of S173), an information management unit 215 stores information included in the mirror packet received in the processing of S151 as mirror information corresponding to the header information that is present in the processing of S171, of the management information 231 (S174).

On the other hand, if the mirror packet information is present (NO of S173), an error notification unit 216 notifies an operator or a user that an error occurs.

In addition, in processing of S171, if the header information extracted in the processing of S161 is not present in the management information 231 (NO of S171), the information management unit 215 stores as part of the management information 231 in the information storage area 230 information that associates the header information extracted in the processing of S161, information included in the mirror packet received in the processing of S151, and the current time (S172).

Then, after the processing of S164, S172, S174, or S175, the packet reception unit 211 performs the processing after S151.

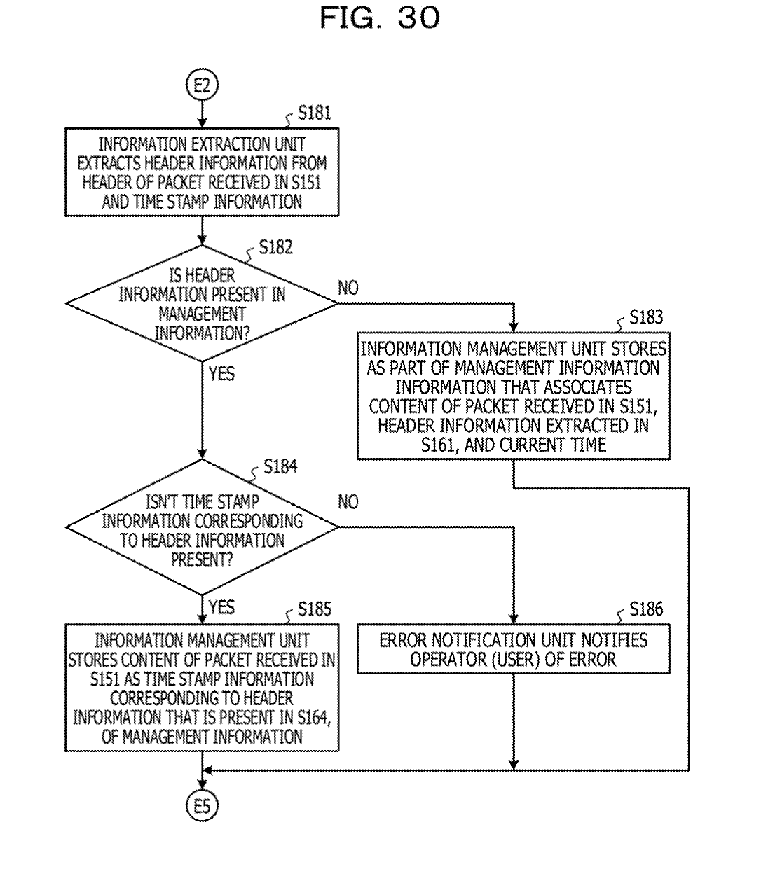

On the other hand, in the processing of S152, if the packet received by the packet reception unit 211 is a time stamp packet (NO of S152), as illustrated in FIG. 30, the information extraction unit 213 extracts header information from a header of the time stamp packet received in the processing of S151 (S181). In addition, in this case, the information extraction unit 213 extracts the time stamp information from the time stamp packet received in the processing of S151 (S181).

Subsequently, the information identification unit 214 determines whether or not the header information extracted in the processing of S181 is present in the management information 231 (S182). Then, if the header information is present in the management information 231 (YES of S182), the information identification unit 214 determines whether or not the time stamp information corresponding to the header information that is present in the processing of S182 is present (S184).

As a result, if the time stamp information is not present (YES of S184), the information management unit 215 stores the time stamp information included in the time stamp packet received in the processing of S151 as time stamp information corresponding to the header information that is present in the processing of S182, of the management information 231 (S185).

On the other hand, if the time stamp information is present (NO of S184), the error notification unit 216 notifies an operator or a user of an operating terminal (not illustrated), for example, that an error occurs.

In addition, in the processing of S182, if the header information extracted in the processing of S181 is not present in the management information 231 (NO of S182), the information management unit 215 stores as part of the management information 231 in the information storage area 230 information that associates the header information extracted in the processing of S181, information included in the time stamp packet received in the processing of S151, and the current time (S183).

Then, after the processing of S183, S185, or S186, the packet reception unit 211 performs the processing after S151 again.

More specifically, if the protocol of the transport layer of the mirror packet received from the switching device 1 is UDP, the capture device 2 performs processing of the same content as the case of the first embodiment. In addition, even if the protocol of the transport layer of the mirror packet received from the switching device 1 is TCP, the capture device 2 performs the processing of the same content as the case of the first embodiment if no time stamp field is present in the TCP header.

As such, the switching device 1 in this embodiment generates a mirror packet by performing mirroring on a system packet flowing through a network. Then, the switching device 1 generates a time stamp packet including header information that uniquely identifies the generated mirror packet and a time stamp packet including the time when the mirroring is performed. Subsequently, the switching device 1 transfers the generated time stamp packet and the mirror packet to the capture device 2.

In addition, the capture device 2 identifies a mirror packet and a time stamp packet, respectively, that include same header information, from the packet received from the switching device, and associates the identified mirror packet with the time included in the identified time stamp packet and stores the mirror packet in the information storage area 230.

This allows the switching device 1 and the capture device 2 to associate a mirror packet with time when that mirror packet is generated (time when mirroring is performed) and stores the mirror packet in the information storage area 230, without changing setting of the MTU or the like or performing fragmentation on the mirror packet. Then, the capture device 2 may analyze the mirror packet, referring to the time when the mirror packet is generated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
receiving, by a switching device coupled to a network, a first packet transmitted through the network;
generating, by the switching device, a first mirror packet of the received first packet by performing a first mirroring processing on the received first packet, the first mirror packet including first identification information identifying the first mirror packet;
generating, by the switching device, a first time stamp packet including the first identification information and first time information indicating a first time when the first mirroring processing is performed;
transmitting, by the switching device, the first mirror packet and the first time stamp packet to a storage device; and
storing, in the storage device, the first mirror packet and the first time stamp packet transmitted from the switching device.

2. The method according to claim 1, wherein
in the generating of the first time stamp packet, the first time stamp packet is generated as a different packet from the first mirror packet.

3. The method according to claim 1, further comprising:
receiving, by the switching device, a second packet transmitted through the network;
generating, by the switching device, a second mirror packet of the received second packet by performing a second mirroring processing on the received second packet, the second mirror packet being including second identification information identifying the second mirror packet;
generating, by the switching device, a second time stamp packet including the second identification information and second time information indicating a second time when the second mirroring processing is performed;
transmitting, by the switching device, the generated second mirror packet and the generated second time stamp packet;
storing, in the storage device, the second mirror packet and the second time stamp packet transmitted from the switching device; and
rearranging, based on the first time information included in the first time stamp packet and the second time information included in the second time stamp packet, the first mirror packet and the second mirror packet based on which of the first mirroring processing and the second mirroring processing is performed earlier.

4. The method according to claim 3, wherein
the first identification information is included in a header of each of the first mirror packet and the first time stamp packet; and
the second identification information is included in a header of each of the second mirror packet and the second time stamp packet.

5. The method according to claim 4, wherein
each of the headers is a TCP header or a UDP header.

6. The method according to claim 2, further comprising:
storing, in a capturing device coupled to the switch device, first management information associating first information included in the first mirror packet with the first identification information included in the first mirror packet;
storing, in the capturing device, second management information associating the first time included in the first time stamp packet with the first identification information included in the first time stamp packet;
identifying, by the capturing device, the first identification information associated with the first information included in the first mirror packet and the first time information, based on the first management information and the second management information; and
storing, by the capturing device in the storage device, the first information included in the first mirror packet corresponding to the identified first identification information and the first time information corresponding to the identified first identification information.

7. The method according to claim 6, further comprising:
deleting, by the capturing device, the first information and the first time information from the first management information and the second management information when the first information included in the first mirror packet and the first time information are stored in the storage device.

8. The method according to claim 6, wherein
when the first time is earlier than the second time, the storage device does not store the first information included in the first mirror packet and the first time information.

9. The method according to claim 6, further comprising:
when a period after the capturing device receives one of the first mirror packet and the first time stamp packet until the storage device receives the other of the first mirror packet and the first time stamp packet exceeds a first period of time, deleting information related to the one of the first mirror packet and the first time stamp packet from the first management information and the second management information.

10. The method according to claim 6, further comprising:
storing, by the capturing device in the storage device, the first information and non-reception information indicating that the first time stamp packet is not received, when a period after the storage device receives the first mirror packet until the storage device receives the first time stamp packet exceeds a second period of time.

11. The method according to claim 6, further comprising:
storing, by the capturing device in the storage device, the first time information and non-reception information indicating that the first mirror packet is not received, when a period after the capturing device receives the first time stamp packet until the capturing device receives the first mirror packet exceeds a third period of time.

12. A switching device configured to be coupled to a network, the switch device comprising:
a memory; and
a processor coupled to the memory, the processor being configured to:
receive a first packet transmitted through the network,
generate a first mirror packet of the received first packet by performing a first mirroring processing on the received first packet, the first mirror packet including first identification information identifying the first mirror packet,
generate a first time stamp packet including the first identification information and first time information indicating a first time when the first mirroring processing is performed, and
transmit the generated first mirror packet and the generated first time stamp packet.

13. The switching device according to claim 12, wherein
the first time stamp packet is generated as a different packet from the first mirror packet.

14. The switching device according to claim 12, the processor is further configured to:
receive a second packet transmitted through the network,
generate a second mirror packet of the received second packet by performing a second mirroring processing on the received second packet, the second mirror packet being including second identification information identifying the second mirror packet,
generate a second time stamp packet including the second identification information and second time information indicating a second time when the second mirroring processing is performed,
transmit the generated second mirror packet and the generated second time stamp packet, and
rearrange, based on the first time information included in the first time stamp packet and the second time information included in the second time stamp packet, the first mirror packet and the second mirror packet based on which of the first mirroring processing and the second mirroring processing is performed in earlier.

15. The switching device according to claim 14, wherein
the first identification information is included in a header of each of the first mirror packet and the first time stamp packet, and
the second identification information is included in a header of each of the second mirror packet and the second time stamp packet.

16. The switching device according to claim 15, wherein
each of the headers is a TCP header or a UDP header.

17. A packet capturing system configured to be coupled to a network, the packet capturing system comprising:
a switching device including a first memory and a first processor coupled to the first memory; and
a capturing device including a second memory and a second processor coupled to the second memory, wherein
the first processor is configured to:
receive a first packet transmitted through the network,
generate a first mirror packet of the received first packet by performing a first mirroring processing on the received first packet, the first mirror packet including first identification information identifying the first mirror packet,
generate a first time stamp packet including the first identification information and first time information indicating a first time when the first mirroring processing is performed, and
transmit the generated first mirror packet and the generated first time stamp packet, and
the second processor is configured to:
store, in a storage device, the first mirror packet and the first time stamp packet transmitted from the switching device.

18. The packet capturing system according to claim 17, wherein
the first time stamp packet is generated as a different packet from the first mirror packet.

19. The packet capturing system according to claim 18, wherein
the first processor is further configured to:
receive a second packet transmitted through the network,
generate a second mirror packet of the received second packet by performing a second mirroring processing on the received second packet, the second mirror packet being including second identification information identifying the second mirror packet,
generate a second time stamp packet including the second identification information and second time information indicating a second time when the second mirroring processing is performed,
transmit the generated second mirror packet and the generated second time stamp packet, and
order, based on the first time information included in the first time stamp packet and the second time information included in the second time stamp packet, the first mirror packet and the second mirror packet based on which of the first mirroring processing and the second mirroring processing is performed in earlier, and
the second processor is further configured to:
store, in the storage device, the second mirror packet and the second time stamp packet transmitted from the switching device.

20. The packet capturing system according to claim 19, wherein
the first identification information is included in a header of each of the first mirror packet and the first time stamp packet; and
the second identification information is included in a header of each of the second mirror packet and the second time stamp packet.
